(19) United States
(12) Patent Application Publication
(10) Pub. No.: US 2007/0101754 A1
(43) Pub. Date: May 10, 2007

(54) Portable temperature maintaining apparatus

(76) Inventor: Santiago Maldonado, Elizabeth, NJ (US)

Correspondence Address: Irwin Ostroff, Esquire;OSTROFF & ASSOCIATES, 3 Lackawanna Boulevard, Murray Hill, NJ, 07974, US

(21) Appl. No.: 11/271,463

(22) Filed: Nov. 10, 2005

(51) Int. Cl. B67D 5/62; F25D 3/08; F25D 23/00

(52) U.S. Cl. 62/389; 62/457.7; 220/592.03

(57) ABSTRACT

A portable temperature maintaining apparatus has primary walls having a relatively high thermal resistance and inner and outer surfaces where the inner surfaces define a primary chamber. One of the primary walls serves as a selectively movable lid such that items can be placed in the primary chamber. At least a first secondary wall is formed within the primary chamber and defines at least a portion of a first secondary chamber existing within the primary chamber capable of storing a free-flowing consumable liquid that is poured into the first secondary chamber. The thermal resistance of the at least first secondary wall is selected to be of relatively low thermal resistance or relatively high thermal resistance. A spigot is provided that passes through a primary wall and into communication with the secondary chamber such that any liquid stored in the secondary chamber can be dispensed therefrom.

### FIELD OF THE INVENTION

The present invention relates to a portable temperature maintaining apparatus, such as a chest including a primary chamber for storing items placed therein at a first temperature of one or more of the items, and at least one secondary chamber formed within the primary chamber for storing a free-flowing liquid therein at essentially the first temperature found within the primary chamber or at a second different temperature from that found in the primary chamber.

### BACKGROUND OF THE INVENTION

Conventional portable coolers are used for storing food and drinks for picnics, parties, the beach, automobile trips, and other similar outdoor activities. A conventional cooler includes a round or rectangular insulated chest with a central cavity defined therein that extends through an upper surface of the chest, and an insulated lid capable of sealing the central cavity when in contact with the entire upper surface of the chest. In use, ice or any other form of coolant is placed in the central cavity along with cans or bottles of drinks, or other foods, to be transported, and the lid is closed to keep the drinks and/or food cool for the period of time they are in the cooler.

U.S. Pat. No. 4,655,052 (Garcia), issued on Apr. 7, 1987, discloses a portable cooler comprising a chest with a main cavity defined therein for storing foodstuffs and coolant, an insulated lid for sealing the main cavity, and an insulated auxiliary cavity. An auxiliary cavity extends out from an outer side wall of the chest and is separated from the main cavity by a transversely extending mesh partition for permitting only cool air from the main cavity to enter the auxiliary cavity. The auxiliary cavity includes at least one circular opening in a top surface thereof for receiving a beverage can that is inserted into the auxiliary cavity and covered with a plug to seal the can within the auxiliary cavity until it is to be removed therefrom.

U.S. Pat. No. 6,629,430 B2 (Mills et al.), issued on Oct. 7, 2003, discloses a cooler comprising a container having a container bottom wall, upstanding side walls from the periphery of the bottom wall defining an open chamber, and a cover wall forming a lid that is connected to one side wall with a hinge for closing and opening the lid. The side walls and cover wall are made of a flexible fabric material with an insulated layer such that the side walls can be folded to allow for the collapse of the container for receiving articles to be cooled in the collapsed state. A bottle for receiving a liquid has peripheral walls and a bottom wall that has a shape to match the bottom and side walls of the container to provide stiffening for the bottom wall. The bottle includes a closure cap for covering an end of a bottle neck that extends through a peripheral side wall of the container when the bottle is inserted into contact with the container bottom for allowing the selective discharge of a liquid placed within the bottle. Generally, a liquid is placed within the bottle and then frozen prior to the bottle being placed within the container to provide a cooling medium for the articles placed thereon within the container.

U.S. Pat. No. 8,671,611 (Quigley), issued on Sep. 30, 1997, discloses a cooler chest comprising insulated outer side walls, a relatively narrow coolant compartment immediately within the insulated side walls that surrounds a central food and beverage compartment. Separate means are used to seal each of the coolant compartment and the central compartment at its top to provide access to each compartment and to reduce any effect from the surrounding ambient temperature. Melting ice in the coolant compartment can not contaminate food in the central food and beverage compartment.

U.S. Pat. No. 6,658,857 (George), issued on Dec. 9, 2003, discloses a dual chamber portable thermoelectric cooling and heating appliance device that is a rectangular box having two thermally separated compartments. Electrical heating and cooling apparatus, powered by an external electrical source, are part of the device.

One problem with some prior art coolers or chests is that one may want to store both hot and/or cold free-flowing liquids, such as cold fruit juice and hot coffee, but can't store containers of each in the same cooler chest since the coffee would be cooled along with the juice when ice is placed in the chest.

It is desirable to provide a non-electric portable chest in which food can be placed in a primary chamber and a consumable liquid or separate consumable liquids can be poured into one or more separate secondary chambers. When there is only one separate secondary chamber, it can store a hot liquid, such as coffee, or a liquid such a fruit juice which is to cooled. In this case of storing hot coffee, the single separate secondary chamber is thermally isolated from the primary chamber. In the case of storing fruit juice which is to be cooled, the single secondary chamber is thermally coupled to the primary chamber in which a coolant, e.g., ice, is placed. When there are two or more secondary chambers, one can be thermally isolated from the primary chamber and used to store a hot liquid, and another can thermally coupled to the primary chamber and used to store a liquid that is to be cooled.

### SUMMARY OF THE INVENTION

From a first apparatus aspect, the present invention is directed to portable temperature maintaining apparatus comprising primary walls, at least a first secondary wall, and a spigot. The primary walls have inner and outer surfaces with the inner surfaces defining a primary chamber. One of the primary walls serves as a selectively movable lid such that items can be placed in the primary chamber. The primary walls all have a relatively high thermal resistance. The at least first secondary wall is formed within the primary chamber and defines at least a portion of a first secondary chamber existing within a portion of the primary chamber. The first secondary chamber is configured to store a free-flowing consumable liquid. The thermal resistance of the at least first secondary wall is either of relatively high thermal resistance or relatively low thermal resistance. The spigot passes through a primary wall and into communication with the secondary chamber such that any liquid stored in the secondary chamber can be dispensed therefrom.

From a second apparatus aspect, the present invention is directed to a portable temperature maintaining apparatus comprising primary walls, a plurality of secondary walls, and at least one spigot. The primary walls have inner and outer surfaces with the inner surfaces defining a primary chamber therein. One of the primary walls serves as a selectively movable lid such that items can be placed in the primary chamber and then sealed therein. The primary walls all have a relatively high thermal resistance. The plurality of secondary walls are formed within the primary chamber. Each secondary wall defines at least a portion of at least one secondary chamber within the primary chamber. One of the secondary walls defines each of at least one secondary chamber and is selectively removable. The at least one secondary chamber is configured to store a consumable liquid. The thermal resistance of each of the secondary walls is selected from either a relatively high thermal resistance or a relatively low thermal resistance. Each spigot passes through a predetermined primary wall and into communication with a separate one of the at least one secondary chamber such that any liquid stored in the associated at least one secondary chamber can be dispensed therefrom.

From a third apparatus aspect, the present invention is directed to a portable chest comprising primary walls, a plurality of secondary walls, and a spigot. The primary walls have inner and outer surfaces with the inner surfaces thereof defining a primary chamber therein. One of the primary walls forms a selectively movable lid such that items can be placed in the primary chamber. The primary walls all have relatively high thermal resistance. The plurality of secondary walls are formed within the primary chamber and define, in conjunction with at least one primary wall, a first secondary chamber existing within the primary chamber. One of the plurality of secondary walls is selectively removable. the first secondary chamber is configured to store a free-flowing consumable liquid. The thermal resistance of each of the secondary walls is selected from a group consisting of a relatively high thermal resistance and a relatively low thermal resistance. The spigot passes through a primary wall and into communication with the secondary chamber such that any liquid stored in the secondary chamber can be dispensed therefrom.

The invention will be better understood from the following more detailed description taken with the accompanying drawings and claims.

### BRIEF DESCRIPTION OF THE DRAWING

FIG. 1 is a perspective view of a portable temperature maintaining chest in accordance with a first embodiment of the present invention;

FIG. 2 is a is a perspective view of a portable temperature maintaining chest in accordance with a second embodiment of the present invention; and

FIG. 3 is a is a perspective view of a portable temperature maintaining chest in accordance with a third embodiment of the present invention.

The drawings are not necessarily to scale.

### DETAILED DESCRIPTION OF THE INVENTION

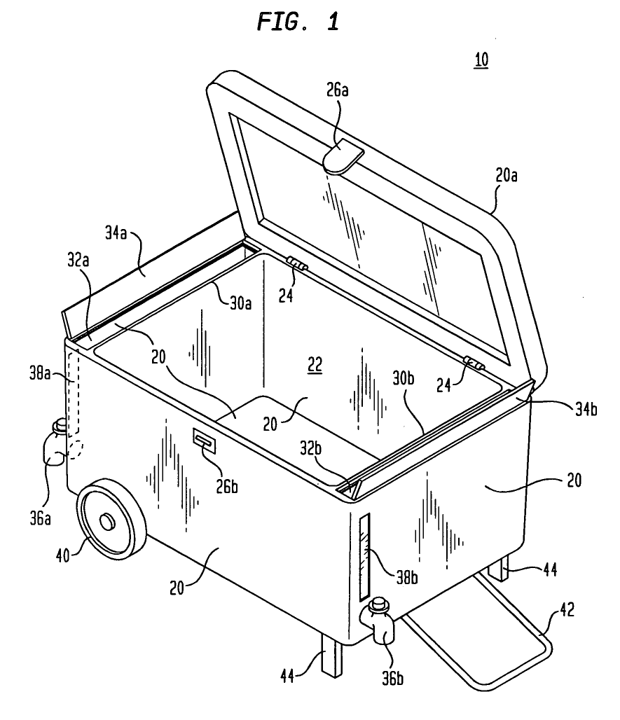

Referring now to FIG. 1, there is shown a perspective view of a portable temperature maintaining apparatus 10, hereinafter referred to as a portable multiple chamber chest 10, in accordance with a first embodiment of the present invention. Apparatus 10 does not require any electrical input power. The chest 10 comprises a plurality of primary walls 20 that form the sides and bottom, and a lid 20a, of the chest 10, each of the primary walls 20 and lid 20a being formed from a high thermal resistance material. The primary walls 20 and lid 20a having inner surfaces that define a primary chamber 22 within the chest 10. The lid 20a is coupled to a primary wall 20 via at least one hinge 24 to permit the lid 20a to be selectively movable for either allowing access to, or sealing, the primary chamber 22. As shown in FIG. 1, there are two separate hinges 24. When sealing the primary chamber 22, the lid 20a is held in place by a latch comprising a male member 26a located on an edge of lid 20a, and a female member 26b located on a front surface of a primary wall 20. Any suitable element (not shown), such as a rubber gasket or 0-ring, can be attached to the edges around the top of the primary side walls 20 such that when the lid 20a is in place to seal the primary chamber 22 such suitable element is compressed.

The chest 10 further comprises a first secondary wall 30a, formed within the primary chamber 22, that defines at least a portion of a first secondary chamber 32a defined within the primary chamber 22. The first secondary chamber 32a is capable of storing a free-flowing consumable liquid (not shown) that is poured into the first secondary chamber 32a. An optional movable lid 34a can be provided for providing access to the first secondary chamber 32a to permit a consumable liquid to be poured into the first secondary chamber 32a, and for sealing the first secondary chamber 32a once a free-flowing liquid is stored in the first secondary chamber 32a and the lid 20a does not seal the first secondary chamber 32a when clamped to seal the primary chamber 22. Such optional lid 34a can be hinged to a primary wall 20 or the first secondary wall 30a defining the first secondary chamber 32a (as shown in the figure), or can be completely removable. Preferferrably, secondary chambers 32a and 32b are of sufficient width and length so as to allow a cleaning tool or a persons hand to be inserted therein for cleaning.

A second secondary wall 30b formed within the primary chamber 22 defines at least a portion of a second secondary chamber 32b defined within the primary chamber 22. The second secondary chamber 32b is capable of storing a second free-flowing consumable liquid (not shown) that is poured into the second secondary chamber 32b. An optional movable lid 34b can be provided for providing access to the second secondary chamber 32b to permit the consumable liquid to be poured into the second secondary chamber 32b, and for sealing the second secondary chamber 32b once the free-flowing consumable liquid is stored in the second secondary chamber 32b and the lid 20a does not seal the second secondary chamber 32b when clamped to seal the primary chamber 22. Such optional lid 34b can be hinged to a primary wall 20 or the second secondary wall 30b defining the second secondary chamber 32b (as shown in the figure), or be completely removable.

The thermal resistance of the each of the first and second secondary walls 30a and 30b being selectively formed from either one of (a) a relatively high thermal resistance to essentially prevent the liquid in the secondary chamber 32a or 32b from being affected by the temperature in the primary chamber 22, and (b) a relatively low thermal resistance to enable a liquid in the secondary chamber 32a or 32b to be affected by the temperature in the primary chamber 22. With a first of the walls 30a being of relatively low thermal resistance, cold items in the primary chambers 22 cause a liquid in the secondary chamber 32a to be cooled if the temperature thereof is above that of the items in the primary chamber 22. In this case the first secondary chamber 32a is said to be thermally coupled to primary chamber 22. With a second of the walls 30a being of relatively high thermal resistance, cold items in the primary chamber 22 have essentially no affect on the temperature of a liquid in the secondary chamber 32b. In this case the second secondary chamber 32b is said to be thermally isolated from the primary chamber 22.

First and second spigots 36a and 36b passing through a same or different primary wall 20 and into communication with the first and second secondary chambers 32a and 32b, respectively, such that any liquid stored in the respective first and second secondary chambers 32a and 32b can be dispensed therefrom. First and second sightglasses 38a and 38b can be optionally provided, the sightglasses 38a and 38b being formed in a same or different primary wall 20 and into communication with the associated first and second secondary chambers 32a and 32b, respectively. They allow one to see the level of a consumable liquid stored within the respective first and second secondary chambers. Wheels 40 can be positioned on the chest 10 to permit the chest 10 to be rolled instead of carried. A handle 42 can also be provided to enable the pulling of the chest 10 via the wheels 40. Handle 42 is shown as a pull out type handle, which when not in use can be pushed under chest chest 10. Two support legs 44 are attached to an outer surface of bottom primary wall 20 so as to help support and level chest 10.

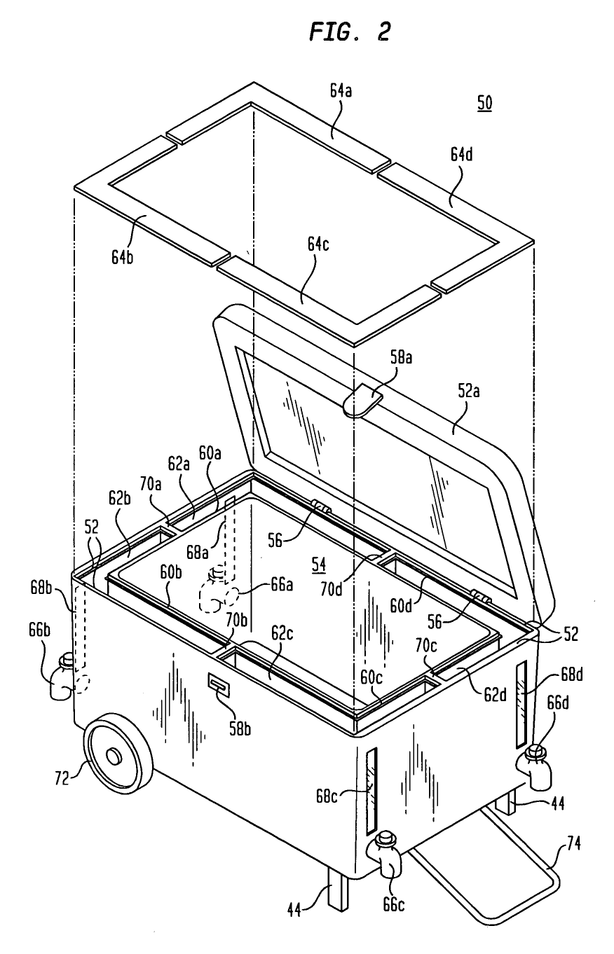

Referring now to FIG. 2, there is shown a perspective view of a portable temperature maintaining apparatus 50, hereinafter referred to as a portable multiple chamber chest 50, in accordance with a second embodiment of the present invention. Apparatus 50 does not require any electrical power to perform its function. The chest 50 comprises a plurality of primary walls 52 that form the sides and bottom, and a lid 52a, of the chest 50, each of the primary walls 52 and lid 52a being formed from a high thermal resistance material. The primary walls 52 and lid 52a having inner surfaces that define a primary chamber 54 within the chest 50. The lid 52a is coupled to a primary wall 52 via at least one hinge 56 to permit the lid 52a to be selectively movable for either allowing access to, or sealing, the primary chamber 54. As shown in FIG. 2, there are two separate hinges 56. When sealing the primary chamber 54, the lid 52a is held in place by a latch comprising a male member 58a located on an edge of the lid 52a, and a female member 58b located on a front surface of a primary wall 52. Any suitable element (not shown), such as a rubber gasket or 0-ring, can be attached to the. edges around the top of the primary side walls 52, or adjacent the edge of the lid 52a, such that when the lid 52a is in place to seal the primary chamber 54 such suitable element is compressed.

The chest 50 further comprises first, second, third, and fourth secondary walls 60a, 60b, 60c, and 60d, respectively, formed within the primary chamber 54 that partly define first, second, third, and fourth secondary chambers 62a, 62b, 62c, and 62d with portions of the primary chamber 54. Separate, fifth, sixth, seventh, and eighth secondary walls 70a, 70b, 70c, and 70d are positioned to be in contact with a predetermined primary wall 52 and one of the first, second, third, and fourth secondary walls 60a, 60b, 60c, or 60d for further defining and providing a separating wall between adjacent secondary chambers 62a, 62b, 62c, or 62d. They also provide support for the primary walls 52 and secondary walls 60a-60d and thus help limit any bulging thereof when liquid fills the secondary chambers 62a, 62b, 62c, and 62d. Each of the fifth, sixth, seventh, and eight secondary walls typically has a relatively high thermal resistance so as to thermally isolate the respective secondary chambers 62a, 62b, 62c, and 62d from each other. The first, second, third, and fourth secondary chambers 62a, 62b, 62c, and 62d are each capable of storing a desired free-flowing consumable liquid (not shown) that is poured into the associated secondary chamber 62a-62d. If the primary lid 52a is not designed to seal each of the secondary chambers 60a-60d when clamped to seal the primary chamber 54, optional first, second, third, and fourth movable secondary lids 64a, 64b, 64c, and 64d can be provided for permitting access to the first, second, third, and fourth secondary chamber 62a, 62b, 62c, and 62d, respectively, when removed in order to pour predetermined consumable liquids to into any of the first, second, third, and fourth secondary chambers 62a-62d. The secondary lids 64a-64d, when placed in contact with the associated primary walls 52 and secondary walls 60a-60d, function to seal the associated first, second, third, and fourth secondary chambers 62a-62d once a free-flowing liquid is stored in the associated secondary chamber 62a, 62b, 62c, or 62d. Each of the optional lids 64a-64d can be optionally hinged to a primary wall 52 or one of the secondary walls 60a-60d, or, as is shown in FIG. 2, can be individually removable. Preferrably, the secondary chambers 62a, 62b, 62c, and 62d are of. sufficient length and width so as to allow a cleaning tool or a persons hand to be inserted therein for cleaning.

The thermal resistance of the each of the first, second, third, and fourth secondary walls 60a, 60b, 60c, and 60d are selectively formed, in the area bordering the associated secondary chamber, from either one of (a) a relatively high thermal resistance to essentially prevent the liquid in the associated secondary chamber 62a, 62b, 62c, or 62d from being affected by the temperature in the primary chamber 54, and (b) a relatively low thermal resistance to enable a liquid in the associated secondary chamber 62a, 62b, 62c, or 62d to be affected by the temperature in the primary chamber 54. With the first, second, third, and fourth secondary walls 60a, 60b, 60c, and 60d all of relatively low thermal resistance, the secondary chambers 62a, 62b, 62c, and 62d are said to be thermally coupled to the primary chamber 52. With the first, second, third, and fourth secondary walls 60a, 60b, 60c, and 60d all of relatively high thermal resistance, the secondary chambers 62a, 62b, 62c, and 62d are said to be thermally isolated from the primary chamber 52. Some of the secondary walls 60a, 60b, 60c, and 60d can be of low thermal resistance and some can be of high thermal resistance. This allows at least one of the secondary chambers 62a, 62b, 62c, and 62d to be used to store a hot liquid and an other one to store a liquid that is to be cooled.

First, second, third, and fourth spigots 66a, 66b, 66c, and 66d pass through a same or different primary wall 52 and are in communication with the first, second, third, and fourth secondary chambers 62a, 62b, 62c, and 62d, respectively, such that any liquid stored in the respective first, second, third, and fourth secondary chambers 62a, 62b, 62c, and 62b can be dispensed therefrom. First, second, third, and fourth sightglasses 68a, 68b, 68c, and 68d can be optionally provided, the sightglasses 68a-68d are formed in a same or different primary wall 52 and into communication with the associated first, second, third, and fourth secondary chambers 62a, 62b, 62c, and 62d, respectively. They allow one to see the level of a consumable liquid stored within the respective first, second, third, and fourth secondary chambers 62a, 62b, 62c, and 62d. Wheels 72 can be positioned on the chest 50 to permit the chest 50 to be rolled instead of carried. A handle 74 can also be provided to enable the pulling of the chest 50 via the wheels 72. Handle 74 is shown as a pull out type handle, which when not in use can be pushed under chest chest 50. Two support legs 76 are attached to an outer surface of bottom primary wall 52 so as to help support and level chest 50.

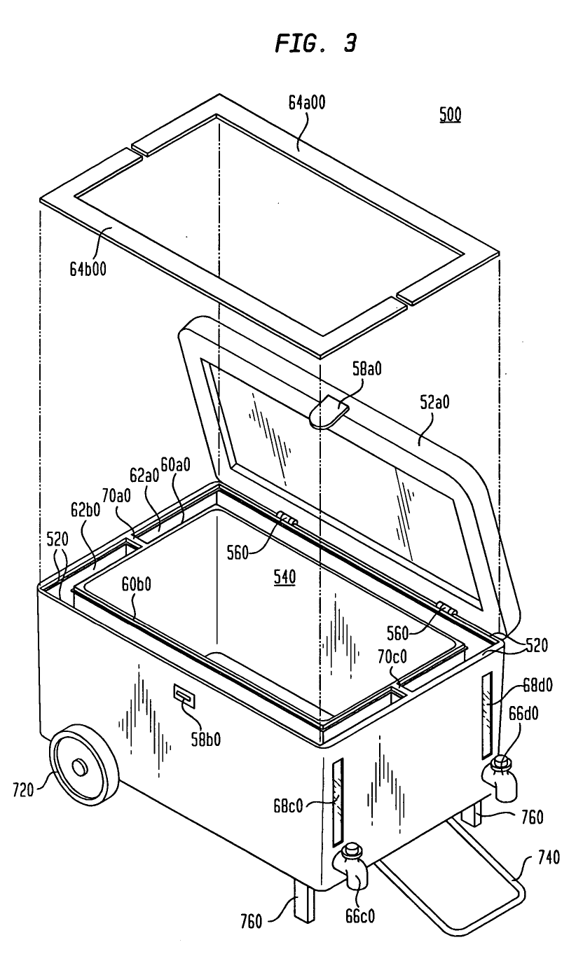

Referring now to FIG. 3, there is shown a perspective view of a portable temperature maintaining apparatus 500, hereinafter referred to as a portable multiple chamber chest 500, in accordance with a second embodiment of the present invention. Apparatus 50 does not require any electrical power to perform its function. Apparatus 500 is very similar to apparatus 50 of FIG. 2 and all components that are essentially the same have the same reference desigation number with a “0” added thereafter. The differences between the two apparatus' is that apparatus 500 has only two secondary chambers 62a0 and 62b0, two spigots 66c0 and 66d0, two lids 64a00 and 64b00, two 68c0 and 68d0, and two secondary divider walls 70a0 and 70c0. Accordingly, apparatus 500 only has two secondary chambers 62a0 and 62b0 in which liquids can stored in and dispensed from via spigots 66c0 and 66d0, respectively.

It is to be appreciated and understood that the specific embodiments of the present invention described hereinabove are merely illustrative of the general principles of the present invention. Various modifications may be made by those skilled in the art which are consistent with the principles set forth. For example, the secondary walls aiding in defining one or more secondary chambers, along with their associated spigots and sightglasses, can be positioned in any preferred arrangement within the primary chamber to provide each secondary chamber size as desired. Still further, there can be any number of secondary chambers with each secondary chamber having an associated spigot. Still further, the lids 20a, 52a, and 52a0 can be configured to seal all of the secondary chambers. With lids 20a, 52a, and 52a0 so configured, the need for lids 34a, 34b, 64a-64d, and 64a00 and 64b00 is eliminated. Still further, the chests 10 and 50 can be squares or other geometric shapes. Furthermore, carrying handles can be added to the chests 10 and 50.

What is claimed is:

1. Portable temperature maintaining apparatus comprising:
primary walls having inner and outer surfaces with the inner surfaces defining a primary chamber, one of the primary walls serving as a selectively movable lid such that items can be placed in the primary chamber, and the primary walls all having a relatively high thermal resistance;
at least a first secondary wall formed within the primary chamber and defining at least a portion of a first secondary chamber existing within the primary chamber, the first secondary chamber being configured to store a free-flowing consumable liquid, the thermal resistance of the at least first secondary wall being selected from a group consisting of a relatively high thermal resistance and a relatively low thermal resistance; and
a spigot passing through a primary wall and into communication with the secondary chamber such that any liquid stored in the secondary chamber can be dispensed therefrom.

2. The apparatus of claim 1 wherein the first secondary wall is fixedly attached within the primary chamber and has a relatively low thermal resistance such that the temperature of items placed in the primary chamber affects the temperature of any liquid in the secondary chamber.

3. The apparatus of claim 1 wherein the first secondary wall has a relatively high thermal resistance such that the temperature of items placed in the primary chamber has essentially no affect on the temperature of any liquid in said secondary chamber.

4. The portable chest of claim 1 wherein the apparatus further comprises a selectively removable second secondary wall forming a lid that is of sufficient size when removed from its position in contact with other walls forming the associated secondary chamber to permit liquid to be added to the first secondary chamber and to facilitate cleaning thereof.

5. The apparatus of claim 1 further comprising:
at least a second secondary wall that is fixedly attached within the primary chamber and at least partially defines a portion of a second secondary chamber that occupies a portion of the primary chamber different from that occupied by the first secondary chamber such that two free-flowing consumable liquids, that can be different from each other, can be stored in the first and second secondary chambers, respectively; and
a second spigot passing through a primary wall and into communication with the second secondary chamber such that any liquid stored in the second secondary chamber can be dispensed therefrom.

6. The apparatus of claim 5 wherein:
the first secondary wall forming the first secondary chamber has a relatively low thermal resistance such that the temperature of items placed in the primary chamber affects the temperature of any liquid in said secondary chamber; and
the second secondary wall forming the second secondary chamber has a relatively high thermal resistance such that the temperature of items in the primary chamber has essentially no little effect on the temperature of a liquid in the secondary chamber.

7. A portable temperature maintaining apparatus comprising:
primary walls having inner and outer surfaces with the inner surfaces defining a primary chamber therein, one of the primary walls serving as a selectively movable lid such that items can be placed in the primary chamber and then sealed therein, the primary walls all having a relatively high thermal resistance;
a plurality of secondary walls formed within the primary chamber, each secondary wall defining at least a portion of at least one secondary chamber within the primary chamber where one of the secondary walls defining each of at least one secondary chamber being selectively removable, the at least one secondary chamber being configured to store a consumable liquid, and the thermal resistance of each of the secondary walls being selected from a group consisting of a relatively high thermal resistance and a relatively low thermal resistance; and
at least one spigot, each spigot passing through a predetermined primary wall and into communication with a separate one of the at least one secondary chamber such that any liquid stored in the associated at least one secondary chamber can be dispensed therefrom.

8. The apparatus of claim 7 wherein at least one primary wall also defining a portion of the each at least one secondary chamber.

9. The apparatus of claim 7 wherein the secondary walls of the at least one secondary chamber are fixedly attached within the primary chamber and have a relatively low thermal resistance such that, with cold items stored in the primary chamber and a consumable liquid stored in the secondary chamber, the temperature of the consumable liquid is cooled if its temperature is above that of the items in the primary chamber.

10. The apparatus of claim 7 wherein the secondary walls of one of the at least one secondary chamber have a relatively high thermal resistance such that, with cold items existing in the primary chamber and a consumable liquid in the secondary chamber, the temperature of the consumable liquid is essentially unchanged.

11. The apparatus of claim 7 wherein:
the plurality of secondary walls define a portion of separate first and second secondary chambers that each occupy a different portion of the primary chamber such that two free-flowing consumable liquids, that can be different from each other, can be stored in the first and second secondary chambers; and
the at least one spigot comprises a first and second spigot, each spigot passing through a predetermined primary wall and into communication with a separate one of the first and second secondary chambers such that any liquid stored in each of the first and second secondary chambers can be dispensed therefrom.

12. The apparatus of claim 11 wherein:
the secondary walls forming the first secondary chamber each having a relatively low thermal resistance such that with cold items existing in the primary chamber, the consumable liquid in the first secondary chamber is cooled if its temperature is above that of the items in the primary chamber; and
the secondary walls forming the second secondary chamber each having a relatively high thermal resistance such that, with cold items existing in the primary chamber, the temperature of the consumable liquid in the second secondary chamber is essentially not affected by the temperature of items in the primary chamber and can be at a different temperature than that of the temperature in the primary chamber.

13. The apparatus of claim 11 wherein:
the secondary walls forming the first and second secondary chambers each having a relatively low thermal resistance such that, with cold items existing in the primary chamber, the consumable liquid stored in the first secondary chamber is cooled.

14. A portable chest comprising:
primary walls having inner and outer surfaces with the inner surfaces thereof defining a primary chamber therein, one of the primary walls forming a selectively movable lid such that items can be placed in the primary chamber, and the primary walls all having a relatively high thermal resistance;
a plurality of secondary walls formed within the primary chamber and defining, in conjunction with at least one primary wall, a first secondary chamber existing within the primary chamber, one of the plurality of secondary walls being selectively removable, the first secondary chamber being configured to store a free-flowing consumable liquid, and the thermal resistance of each of the secondary walls being selected from a group consisting of a relatively high thermal resistance and a relatively low thermal resistance; and
a spigot passing through a primary wall and into communication with the first secondary chamber such that any liquid stored in the first secondary chamber can be dispensed therefrom.

15. The portable chest of claim 14 wherein the one of the primary walls forming a selectively movable lid that serves for gaining access to, and sealing, the primary and secondary chambers being selected from a group consisting of (a) being coupled to another primary wall via at least one hinge and (b) being completely removable.

16. The portable chest of claim 14 wherein the selectively removable secondary wall is of sufficient size when removed from its position in contact with the other walls of the associated first secondary chamber to permit access for easily cleaning the associated first secondary chamber.

17. The portable chest of claim 14 wherein the first secondary chamber includes a sightglass formed in a primary wall of the primary chamber that is in communication with the first secondary chamber for indicating a level of a liquid within the first secondary chamber.

18. The portable chest of claim 14 further comprising:
a handle coupled to the outer surface of one of the primary walls; and
wheels attached to an outer surface of the primary walls.

19. The portable chest of claim 14 wherein some of the plurality of secondary walls are fixedly attached to one of the primary walls and some of the plurality of secondary walls define a second secondary chamber within a portion of the primary chamber.

20. The portable chest of claim 19 wherein one of the first and second secondary chambers has a secondary wall having a relatively high thermal resistance that is in communication with a portion of the primary chamber such that the temperature of items in the primary chamber has essentially no effect on the temperature of a liquid in the secondary chamber which contains the high thermal resistance secondary wall.

21. The portable chest of claim 20 wherein the other of the first and second secondary chambers has a secondary wall having a relatively low thermal resistance and is in communication with a portion of the primary chamber such that the temperature of items placed in the primary chamber affects the temperature of any liquid in said secondary chamber.
